(19) United States
(12) Patent Application Publication
(10) Pub. No.: US 2013/0127264 A1
(43) Pub. Date: May 23, 2013

(54) COMBINATION DRIVE FOR ROTARY AND LIFTING MOVEMENTS, AND LINEAR MOTOR WITH REDUCED INERTIAS

(71) Applicants: Michael FICK, Sondernau (DE); Armin STÄBLEIN, Fladungen (DE); Rolf VOLLMER, Gersfeld (DE)

(72) Inventors: Michael FICK, Sondernau (DE); Armin STÄBLEIN, Fladungen (DE); Rolf VOLLMER, Gersfeld (DE)

(73) Assignee: Siemens Aktiengesellschaft, Munchen (DE)

(21) Appl. No.: 13/469,243

(22) Filed: May 11, 2012

(30) Foreign Application Priority Data
May 13, 2011 (EP) 11166062

(51) Int. Cl. H02K 16/00; H02K 41/03

(52) U.S. Cl. CPC H02K 16/00; H02K 41/031
USPC 310/12.13; 310/12.18

(57) ABSTRACT

A combination drive for rotary and lifting movements includes a rotary motor and a linear motor as well as an output shaft which is caused to rotate by the rotary motor and caused to move linearly by the linear motor. The output shaft includes an output end. The rotary motor is arranged closer to the output end of the output shaft than the linear motor. The output shaft can be designed shorter as a result. Further measures for increasing the dynamics are mass reductions on the rotor of the linear motor.

### CROSS-REFERENCES TO RELATED APPLICATIONS

This application claims the priority of European Patent Application, Serial No. 11166062.7, filed May 13, 2011, pursuant to 35 U.S.C. 119(a)-(d), the content of which is incorporated herein by reference in its entirety as if fully set forth herein.

### BACKGROUND OF THE INVENTION

The present invention relates to a combination drive for rotary and lifting movements.

The following discussion of related art is provided to assist the reader in understanding the advantages of the invention, and is not to be construed as an admission that this related art is prior art to this invention.

Combination drives are used for driving tasks which require a rotary movement and a linear movement. It is advantageous in this connection if these movements can be freely adjusted independently of each other in terms of angle and path. There is frequently also the additional requirement that the movements should take place highly dynamically.

Usually relatively inflexible drives with corner gears have previously been used when implementing combination drives. The dynamics of the combination drive can be significantly improved by way of example by purposeful decoupling of the inertias for linear and rotary movement. A desired increase in the acceleration capacity in particular consequently results.

It would therefore be desirable and advantageous to improve the dynamics of a combination drive for rotary and lifting movements or that of a linear motor.

### SUMMARY OF THE INVENTION

According to one aspect of the present invention, a combination drive for rotary and lifting movements includes a rotary motor, a linear motor, and an output shaft caused to rotate by the rotary motor and caused to move linearly by the linear motor, said output shaft having an output end, wherein the rotary motor is arranged closer to the output end of the output shaft than the linear motor

As the rotary motor is arranged closer to the output end of the output shaft than the linear motor (i.e. the rotary motor is arranged on the output or on the output end of the combination drive), the output shaft does not have to completely protrude through the linear motor. This leads to a reduction in the length of the output shaft compared with the case where the rotary motor is arranged on the opposing side of the linear motor. This does result in a reduction in the mass of the output shaft, however, and therefore a reduction in the inertia of the combination drive as a whole.

According to another advantageous feature of the present invention, the linear motor can have a tubular design. Linear motors of this kind are characterized by a high power density over their length.

According to another aspect of the present invention, a cylindrical linear motor, in particular for a combination drive for rotary and lifting movements, includes a tubular rotor, permanent magnets arranged on the rotor in an axial direction, and an output shaft caused to move linearly by the linear motor, wherein the rotor has a wall thickness which varies in the axial direction at least in certain sections in accordance with an arrangement of the permanent magnets.

The advantage of the variation in the wall thickness of the rotor in the axial direction lies in the fact that the wall thickness is less in some regions of the rotor than the maximum wall thickness. This results in a reduction in the inertia of the rotor compared with the case where the wall thickness of the rotor matches the maximum value along the entire axial extent and is primarily constant. Use is made in particular here of the knowledge that in certain regions of a rotor with constant wall thickness the magnetic flux is lower than at other points. The manifestation of the magnetic flux varies namely in accordance with the pole pitch. Within the context of improved dynamics it is then unnecessary to keep ready those sections of the rotor wall which conduct only a low magnetic flux.

According to another advantageous feature of the present invention, the tubular rotor can have an inner wall of a wave-like profile in the axial direction. It is particularly advantageous when the this wave-like profile recreates the propagation of the magnetic flux in the soft-magnetic rotor material.

According to another advantageous feature of the present invention, the permanent magnets can be arranged on the rotor in accordance with a pole pitch, with the wall thickness of the rotor being less than or equal to one third of the pole pitch. Such a wall thickness ensures a relatively unhindered magnetic flux with simultaneous minimization of the weight.

According to another advantageous feature of the present invention, a plastic tube can be inserted in the rotor to stiffen the rotor. This has the advantage that the mechanical strength of the rotor can consequently be increased by a material which is lighter than the ferroelectrical material of the rotor.

According to another advantageous feature of the present invention, the rotor and the plastic tube can define a cavity there between which is filled with material. This measure also increases the stiffness of the rotor with a thin wall thickness.

According to still another aspect of the present invention, a cylindrical linear motor includes a tubular rotor, permanent magnets arranged on the rotor, wherein a majority of the permanent magnets being spaced apart from each other in a circumferential direction by a standard distance, wherein some of the permanent magnets being spaced apart from each other in the circumferential direction by at least one gap which runs in an axial direction and is sized greater than the standard distance, and an output shaft caused to move linearly by the linear motor.

A magnetic gap is therefore advantageously provided on the rotor in the tangential direction or circumferential direction. A magnetic gap of this kind is expedient in particular if the stator also has a magnetic gap at this point. Unnecessary permanent magnets can thus be omitted, so the percentage by weight of the permanent magnets on the rotor is reduced.

According to another advantageous feature of the present invention, the ratio between a coverage of the rotor by magnets in the axial direction and the pole pitch is preferably 50% to 85%. A low weight and high efficiency result with this percentage range.

According to still another aspect of the present invention, a cylindrical linear motor includes a tubular rotor including at least one rotor bearing shield having spokes, and an output shaft secured to the rotor bearing shield and caused to move linearly by the linear motor.

The rotor bearing shield is advantageously not of a solid design therefore and instead has spokes. The spokes provide the required radial stiffness and the openings in the rotor bearing shield between the spokes lead to a corresponding reduction in weight.

According to still another aspect of the present invention, a cylindrical linear motor includes a tubular stator having a guide rod, a tubular rotor including at least one rotor bearing shield having a sliding bearing supporting the rotor bearing shield for linear movement on the guide rod of the stator, and an output shaft caused to move linearly by the linear motor.

The rotor is therefore advantageously linearly mounted on the stator without the aid of a ball bearing or rolling bearing. Instead a sliding bearing is used for linear mounting and this is much lighter than said other types of bearing.

According to another advantageous feature of the present invention, the output shaft may be configured as a hollow shaft. This also leads to a reduction in weight and therefore to a reduction in the inertia of the combination drive compared with a drive with a solid shaft.

The above-described features can be combined as desired. A combination drive by way of example can therefore have the rotary motor closer to the output end of the output shaft than the linear motor, and at the same time the wall thickness of the rotor varies in the axial direction at least in certain sections in accordance with the arrangement of the permanent magnets. The combination drive can also includes a rotor with magnetic gaps in the circumferential direction and a rotor bearing shield with spokes. The linear motors or combination drives can, moreover, also have sliding bearings for mounting of the rotor. A combination drive according to the present invention can also include all of the above features simultaneously if these are not stated as alternatives.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross-section of a combination drive according to the present invention for rotary and lifting movements;

FIG. 2 is a cross-section of a rotor of a linear motor by way of example of the combination drive of FIG. 1;

FIG. 3 is a perspective view of the rotor of FIG. 2;

FIG. 4 is a perspective view of the rotor of FIG. 3 on guide rods for linear mounting; and

FIG. 5 is a longitudinal section of the rotor of FIG. 4.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

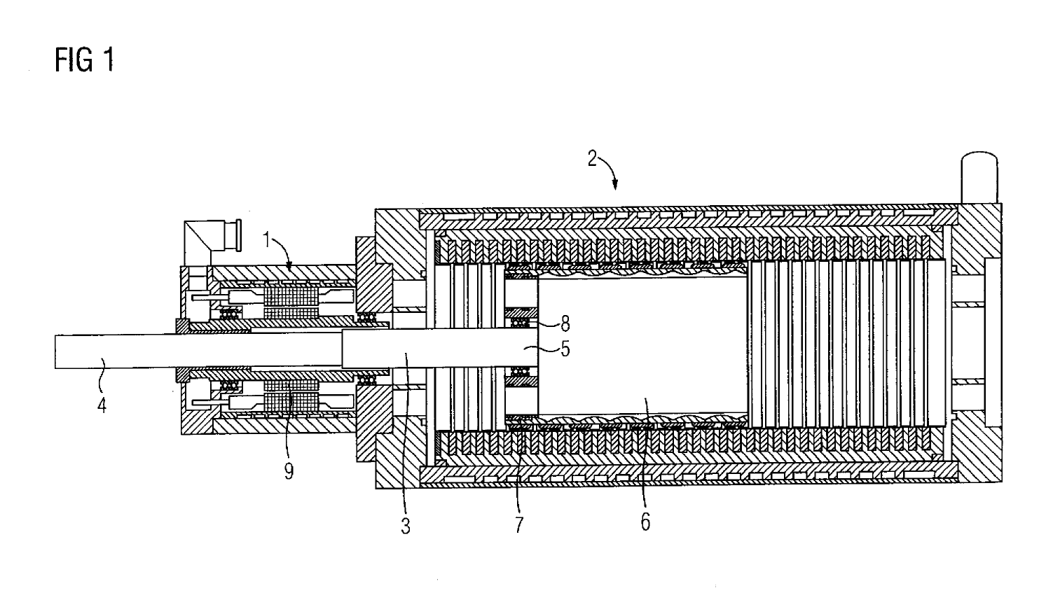

Turning now to the drawing, and in particular to FIG. 1, there is shown a cross-section of a combination drive according to the present invention for rotary and lifting movements. The combination drive for rotary and lifting movements shown in FIG. 1 can be used by way of example for machine tools or robots. It has a rotary motor 1 and a linear motor 2. Both drive an output shaft 3.

The combination drive has an output by which the effective output is made available. In the example of FIG. 1 the output is located on the left and the corresponding effective output is made available by the output shaft 3. The output shaft 3 accordingly has an output end 4 and a drive end 5.

The rotary motor 1 (motor for rotary motion or rotation motor) is located closer to the output of the combination drive than the linear motor 2. However, this also means that the rotary motor 1 is closer to the output side 4 of the output shaft 3 than the linear motor 2.

The output shaft 3 protrudes completely through the rotary motor 1 here, and its drive end 5 is mounted on the rotor 6 of the linear motor 2. The linear motor 2 has a cylindrical design here. The rotor 6 therefore also has a cylindrical or tubular design. The rotor 6 has a bearing shield 7, in which the output shaft 3 is rotatably mounted, on the side facing the rotary motor 1 or the output. A corresponding axial bearing 8 is provided for this purpose. The output shaft 3 is therefore axially fixed to the tubular rotor 6 but rotationally decoupled.

By contrast the output shaft 3 is non-rotatably connected to the rotor 9 of the rotary motor 1. This is achieved by way of example by corresponding tongues and grooves on the output shaft 3 and rotor 9. The output shaft 3 can be axially displaced in the rotary motor 1 as a result. The output shaft is therefore axially decoupled from the rotary motor 1 in relation to the linear motion of the linear motor.

With this combination drive the rotor 6 of the linear motor 2 and the rotor 9 of the rotary motor 1 are therefore decoupled from each other. This significantly reduces the inertia of the drive.

A further reduction in the inertia is achieved in that the rotary motor 1 is arranged at the output end. The output shaft 3 consequently does not have to protrude through the entire linear motor 2. The output shaft 3 can consequently be designed so as to be substantially shorter than in the case where the rotary motor is arranged at the other end of the linear motor 2. In the latter case the output shaft 3 must not only protrude through the linear motor 2, but must also protrude by at least the linear lift into the rotary motor if they are linearly arranged one behind the other.

This results in significant advantages in particular in the case of a large lift of the linear motor, because the output shaft 3 then does not have to be led through the long linear motor. The output shaft 3 can therewith be constructed so as to be short and therefore low in mass and inertia.

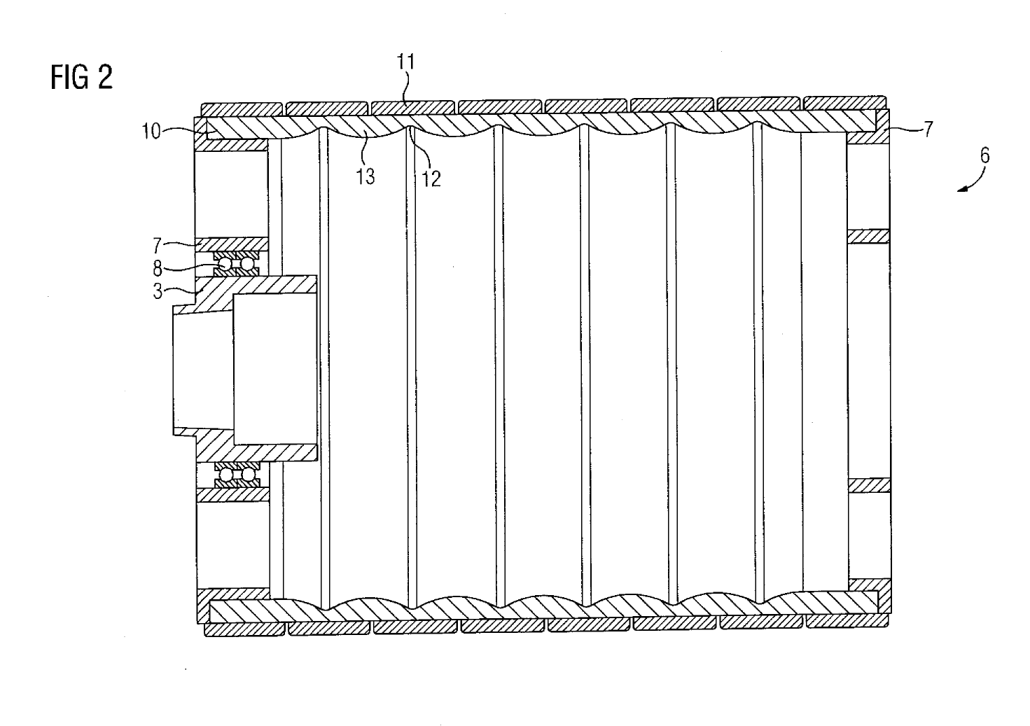

The inertia of the linear motor and therewith of the combination drive with respect to its linear motion can be reduced further in that the mass of the rotor of the linear motor is reduced. According to FIG. 2 this can be achieved in the case of the cylindrical linear motor in that the mass of the rotor tube 10 of the rotor 6 is reduced.

The rotor tube 10 is made from a ferromagnetic material and carries permanent magnets 11 that are distributed on its outer side in the circumferential direction. The rotor tube 10 has the task of guiding or concentrating the magnetic fields of the permanent magnets 11. In order to be able to adequately fulfill this task a certain wall thickness of the rotor tube 10 is required.

A large number of permanent magnets 11 are arranged on the rotor tube 10 in the axial direction. In the present case there are eight permanent magnets axially one behind the other. Eight poles accordingly form on the rotor in the axial direction. The magnetic return of two adjacent poles takes place via the ferromagnetic rotor tube 10. The corresponding magnetic flux forms in the rotor tube 10 in an arcuate manner. It reaches its lowest point in the rotor tube 10 between two permanent magnets 11. The magnetic flux in the rotor tube 10 is at its lowest in the center below each of the permanent magnets, which are arranged here with alternating polarity (north pole, south pole).

In accordance with the inventive idea mass is reduced on the drive where it can be spared. In the present example the majority of the respective magnetic flux is conveyed in only a small region of the rotor tube 10. Regions in which only a small proportion of the magnetic flux is conveyed in the case of a rotor tube with a constant wall thickness can therefore be omitted. The inner contour of the rotor tube 10 can therefore be adapted to the form of the magnetic fields or magnetic fluxes here. Since the lowest magnetic fluxes occur immediately below the individual permanent magnets 11, material is spared at these locations. The wall thickness of the rotor tube 10 is lowest there accordingly. These locations of lower wall thickness 12 extend along the entire circumference of the rotor tube 10. They are situated here in the center below each permanent magnet 11 or behind each series of permanent magnets 11 formed on the circumference. The only exceptions here are in the case of the end-face permanent magnets 11 because the wall thickness of the rotor tube is not reduced here for assembly and stability reasons.

Between the locations 12 of minimal wall thickness of the rotor tube 10 are produced corresponding locations 13 of maximum wall thickness. The magnetic flux is at its greatest here.

While the outer surface of the cylindrical rotor tube 10 runs in a straight line in the axial direction, the inner surface of the cylindrical rotor tube 10 has a corresponding wavy or curved shape in the axial direction. It is characterized by the locations 12 of minimum wall thickness and the locations 13 of maximum wall thickness of the rotor tube 10. The axial distance between the minimum values 12 and maximum values 13 results from the pole pitch. In particular the distance of two minimum values 12 or two maximum values 13 matches the pole pitch of the linear motor.

Due to the fact that the wall thickness of the soft-magnetic rotor tube 10 is therefore reduced at certain locations 12, the mass of the rotor 6 is reduced accordingly. In principle the wall thickness could have the value 0 mm at these locations 12, although this is less favorable from a practical perspective. The minimum wall thickness is therefore matched to the required stiffness.

It has been found with respect to the maximum wall thickness at the corresponding locations 13 that a wall thickness of one third of the pole pitch can be regarded as optimum. This wall thickness ensures the necessary magnetic flux with the lowest expenditure of material. The stiffness of the rotor tube also decreases due to the reduction in the wall thickness of the rotor tube 10. A lightweight supporting construction made of low-density materials can therefore be installed for stiffening purposes. A plastic tube by way of example is inserted in the rotor tube 10 for this purpose. The plastic tube can be reinforced with carbon fiber or glass fiber. It has a lower density than the soft-magnetic rotor tube 10. It can still significantly increase the stiffness of the rotor 6 if it is pressed into the soft-magnetic rotor tube 10 by way of example. Cavities which form between the soft-magnetic rotor tube 10 and the plastic tube can optionally be filled. This increases the stiffness further.

In the exemplary embodiment of FIG. 2 a rotor bearing shield 7 is arranged on both end faces of the rotor 6. An axial bearing 8 (cf. FIG. 1) in which the output shaft 3 is mounted is located in the left rotor bearing shield 7. Only a stub of this output shaft 3 is shown in FIG. 2. The output shaft 3 is also designed as a hollow shaft here. As a result the mass is reduced compared with a solid shaft, and this in turn has a positive effect on the inertia.

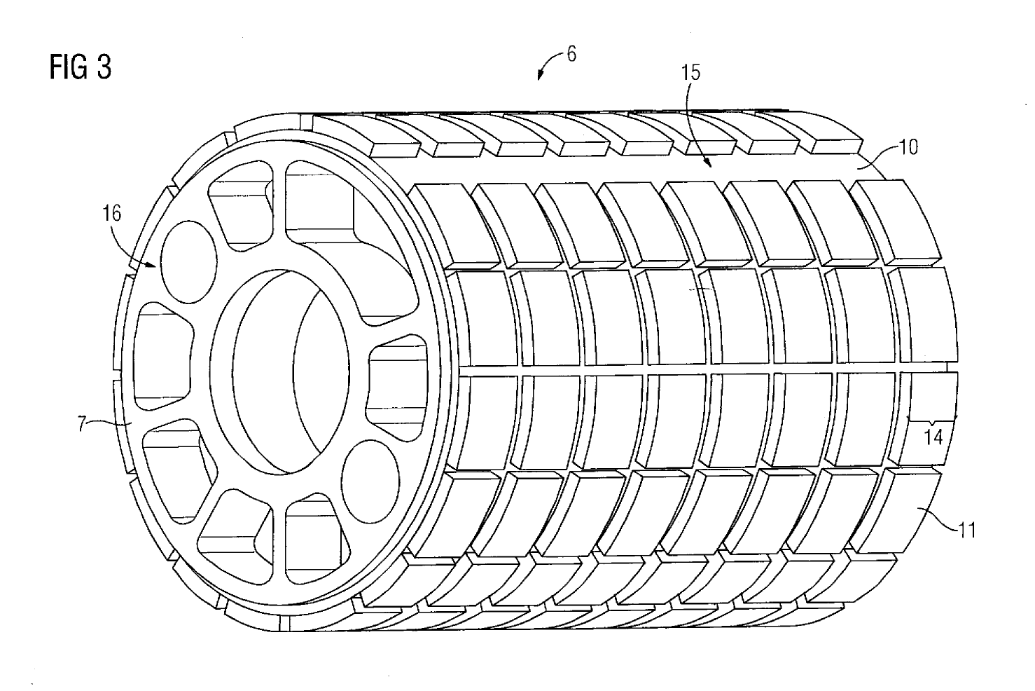

A further measure to reduce the inertia of the linear motor, and therewith optionally of the combination drive as well, will now be described with the aid of FIG. 3. FIG. 3 shows the rotor from FIG. 2 in a perspective view. The permanent magnets 11 are located on the rotor tube 10 distributed over the entire outer surface. They have a rectangular shape here and are arranged on the surface in a grid. Eight permanent magnets 11 are located one behind the other in the axial direction here. They lead to a corresponding pole pitch 14.

The permanent magnets 11 on the rotor 6 do not cover it completely. Instead they lead to a partial pole coverage. It is particularly advantageous in this connection if the axial pole coverage is 50% to 85% of the pole pitch. The ratio of force and mass is increased by this specific ratio of pole coverage to pole width. Permanent magnets may also be spared in this way, reducing the magnet costs of the rotor.

The pole coverage can optionally also be reduced in the circumferential direction. This is the case in particular if the stator of the linear motor has magnetic gaps in the circumferential direction which originate by way of example from an axially extending circuit of the ring coils of the stator. In the example of FIG. 3 a magnetic gap 15 is therefore provided on the rotor tube 10 in the circumferential direction or the tangential direction. It is wider than the standard distance (regular distance) of the permanent magnets in the circumferential direction which the majority of permanent magnets have from each other at the circumference. Since the rotor 6 does not turn, the magnetic gap is located radially below the magnetic gap in the stator. Permanent magnets at this point of the rotor would have little benefit here and are therefore omitted. This again results in reductions in mass and inertia.

One or more of these magnetic gaps 15 can be arranged distributed on the circumference of the rotor. They extend over the entire length of the rotor 6 in the axial direction.

A further possibility of reducing the mass of the rotor 6 consists in saving material in the rotor bearing shield(s) 7. In particular it is advantageous if the rotor bearing shield 7 of the cylindrical rotor 6 comprises corresponding recesses. In the example of FIG. 3 the rotor bearing shield 7 comprises a plurality of recesses distributed over the circumference, so only spokes 16 remain between the individual recesses. The spokes 16 provide the required stiffness, and unnecessary material is avoided in the rotor bearing shield. The rotor bearing shield with spokes therefore also leads to a reduction in inertia.

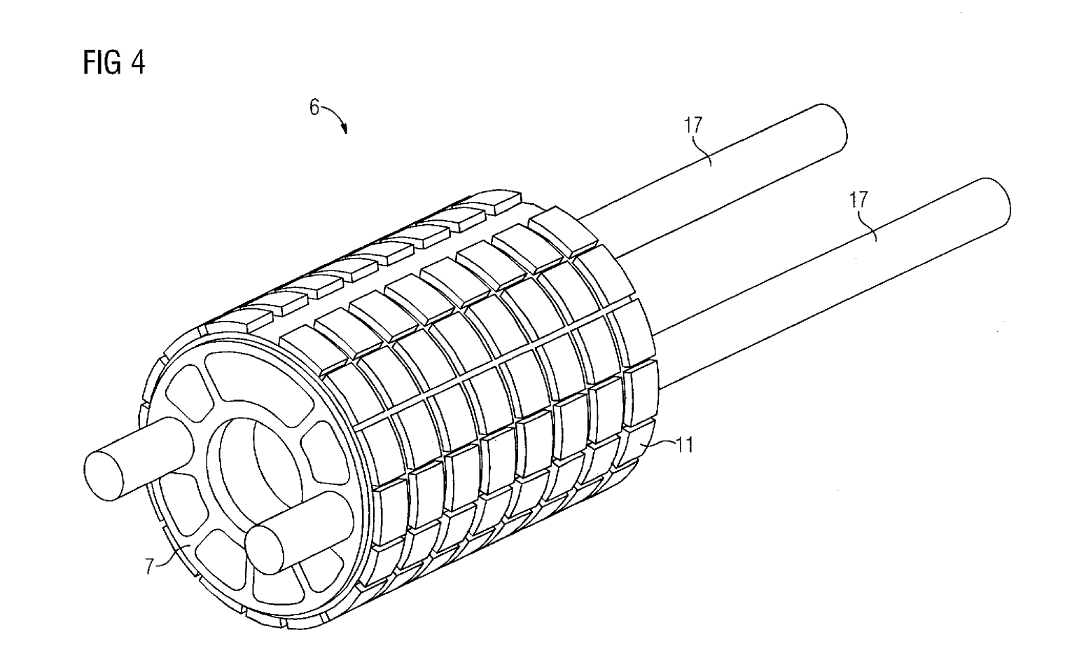

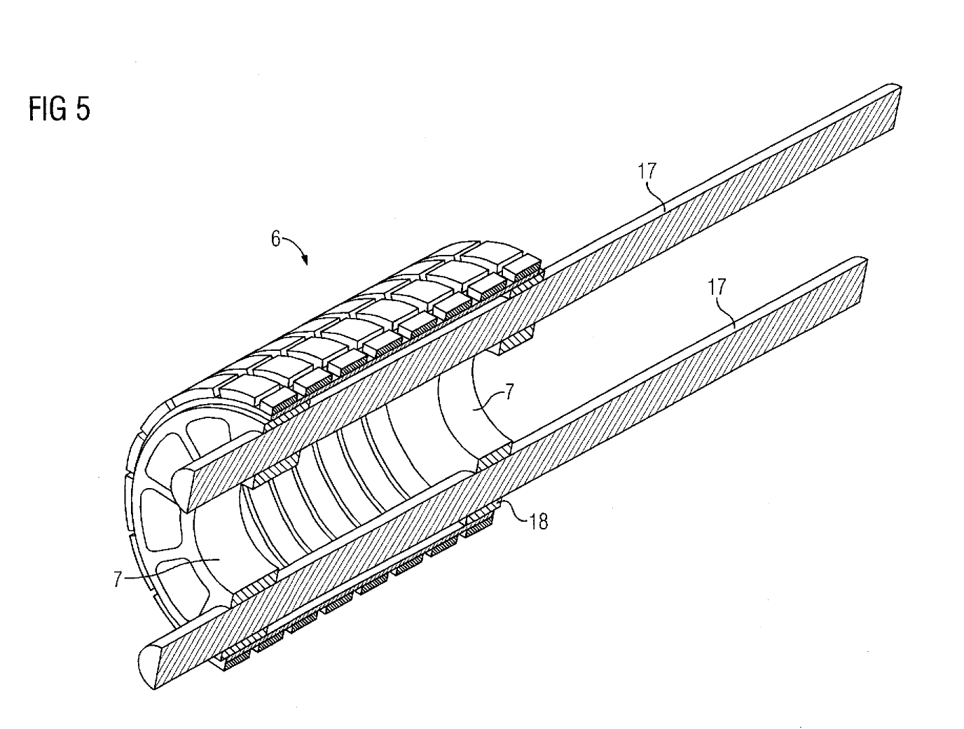

A further embodiment of the present invention, with which the inertia of a cylindrical linear motor can be reduced, will be illustrated with the aid of FIG. 4 and FIG. 5. The rotor 6 shown in FIG. 4 matches that in FIG. 3. The rotor 6 has a bearing shield 7 at both end faces. Two guide rods 17 are guided through the two bearing shields 7 in the axial direction. The rotor 6 is mounted on the guide rods 17 so as to be secured against rotation but linearly moveable.

The longitudinal section in FIG. 5 shows the mounting of the rotor 6 on the guide rods 17 in detail. A saving in weight can be achieved by using sliding bearings instead of ball or rolling bearings. In the example of FIG. 5 corresponding sliding bushings 18 are therefore provided in the bearing rotor shields 7. The guide rods 17 can move linearly in the sliding bushings 18. The guide rods 17 are secured to the stator of the linear motor, so the cylindrical rotor 6 can thereby move linearly inside the cylindrical stator of the linear motor. The low-mass sliding bushings 18 allow more dynamic movements of the rotor 6 accordingly.

A linear motor or combination drive with higher acceleration capacity can therefore be achieved with all of the above measures. Each of the cited features contributes to an improvement in the dynamics.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A combination drive for rotary and lifting movements, comprising:
a rotary motor;
a linear motor; and
an output shaft caused to rotate by the rotary motor and caused to move linearly by the linear motor, said output shaft having an output end,
wherein the rotary motor is arranged closer to the output end of the output shaft than the linear motor.

2. The combination drive of claim 1, wherein the linear motor is tubular in shape.

3. The combination drive of claim 1, wherein the linear motor has a tubular rotor and permanent magnets arranged on the rotor, said rotor having a wall thickness which varies in an axial direction at least in certain sections in accordance with an arrangement of the permanent magnets on the rotor.

4. The combination drive of claim 1, wherein the linear motor has a tubular rotor and permanent magnets arranged on the rotor, wherein a majority of the permanent magnets is spaced apart from each other in a circumferential direction by a standard distance, wherein a minority of the permanent magnets are spaced apart from each other in the circumferential direction by at least one gap which runs in an axial direction and is sized greater than the standard distance.

5. The combination drive of claim 1, wherein the linear motor has a tubular rotor which includes at least one rotor bearing shield having spokes.

6. The combination drive of claim 1, wherein the linear motor includes a tubular stator including a guide rod, and a tubular rotor, said tubular rotor including a rotor bearing shield having a sliding bearing supporting the rotor bearing shield for linear movement on the guide rod of the stator.

7. A cylindrical linear motor, comprising:
a tubular rotor;
permanent magnets arranged on the rotor in an axial direction; and
an output shaft caused to move linearly by the linear motor,
wherein the rotor has a wall thickness which varies in the axial direction at least in certain sections in accordance with an arrangement of the permanent magnets.

8. The cylindrical linear motor of claim 7 for use in a combination drive for rotary and lifting movements.

9. The cylindrical linear motor of claim 7, wherein the tubular rotor has an inner wall of a wave-like profile in the axial direction.

10. The cylindrical linear motor of claim 7, wherein the permanent magnets are arranged on the rotor in accordance with a pole pitch, with the wall thickness of the rotor being less than or equal to one third of the pole pitch.

11. The cylindrical linear motor of claim 7, further comprising a plastic tube inserted in the rotor to stiffen the rotor.

12. The cylindrical linear motor of claim 11, wherein the rotor and the plastic tube define a cavity there between which is filled with material.

13. The cylindrical linear motor of claim 7, wherein the output shaft is a hollow shaft.

14. The cylindrical linear motor of claim 7, wherein a majority of the permanent magnets is spaced apart from each other in a circumferential direction by a standard distance, wherein a minority of the permanent magnets is spaced apart from each other in the circumferential direction by at least one gap which runs in an axial direction and is sized greater than the standard distance.

15. The cylindrical linear motor of claim 7, wherein the tubular rotor includes at least one rotor bearing shield having spokes.

16. The cylindrical linear motor of claim 7, further comprising a tubular stator including a guide rod, said tubular rotor including a rotor bearing shield having a sliding bearing supporting the rotor bearing shield for linear movement on the guide rod of the stator.

17. A cylindrical linear motor, comprising:
a tubular rotor;
permanent magnets arranged on the rotor, wherein a majority of the permanent magnets being spaced apart from each other in a circumferential direction by a standard distance, wherein some of the permanent magnets being spaced apart from each other in the circumferential direction by at least one gap which runs in an axial direction and is sized greater than the standard distance; and
an output shaft caused to move linearly by the linear motor.

18. The cylindrical linear motor of claim 17 for use in a combination drive for rotary and lifting movements.

19. The cylindrical linear motor of claim 17, wherein a ratio between a coverage of the rotor by the permanent magnets in the axial direction and a pole pitch is 50% to 85%.

20. The cylindrical linear motor of claim 17, wherein the output shaft is a hollow shaft.

21. The cylindrical linear motor of claim 20, wherein the rotor is tubular and has a wall thickness which varies in an axial direction at least in certain sections in accordance with an arrangement of the permanent magnets on the rotor.

22. The cylindrical linear motor of claim 17, wherein the tubular rotor includes at least one rotor bearing shield having spokes.

23. The cylindrical linear motor of claim 17, further comprising a tubular stator including a guide rod, said tubular rotor including a rotor bearing shield having a sliding bearing supporting the rotor bearing shield for linear movement on the guide rod of the stator.

24. A cylindrical linear motor, comprising:
a tubular rotor including at least one rotor bearing shield having spokes; and
an output shaft secured to the rotor bearing shield and caused to move linearly by the linear motor.

25. The cylindrical linear motor of claim 24 for use in a combination drive for rotary and lifting movements.

26. The cylindrical linear motor of claim 24, wherein the output shaft is a hollow shaft.

27. The cylindrical linear motor of claim 24, further comprising permanent magnets arranged on the rotor, said rotor having a wall thickness which varies in an axial direction at least in certain sections in accordance with an arrangement of the permanent magnets on the rotor.

28. The cylindrical linear motor of claim 24, wherein a majority of the permanent magnets is spaced apart from each other in a circumferential direction by a standard distance, wherein a minority of the permanent magnets is spaced apart from each other in the circumferential direction by at least one gap which runs in an axial direction and is sized greater than the standard distance.

29. The cylindrical linear motor of claim 24, further comprising a tubular stator including a guide rod, said tubular rotor including a rotor bearing shield having a sliding bearing supporting the rotor bearing shield for linear movement on the guide rod of the stator.

30. A cylindrical linear motor, comprising:
a tubular stator including a guide rod;
a tubular rotor including at least one rotor bearing shield having a sliding bearing supporting the rotor bearing shield for linear movement on the guide rod of the stator; and
an output shaft caused to move linearly by the linear motor.

31. The cylindrical linear motor of claim 30 for use in a combination drive for rotary and lifting movements.

32. The cylindrical linear motor of claim 30, wherein the output shaft is a hollow shaft.

33. The cylindrical linear motor of claim 30, further comprising permanent magnets arranged on the rotor, said rotor having a wall thickness which varies in an axial direction at least in certain sections in accordance with an arrangement of the permanent magnets on the rotor.

34. The cylindrical linear motor of claim 30, wherein a majority of the permanent magnets is spaced apart from each other in a circumferential direction by a standard distance, wherein a minority of the permanent magnets is spaced apart from each other in the circumferential direction by at least one gap which runs in an axial direction and is sized greater than the standard distance.

35. The cylindrical linear motor of claim 30, wherein the tubular rotor includes at least one rotor bearing shield having spokes.
